(19) United States
(12) Patent Application Publication
(10) Pub. No.: US 2008/0179958 A1
(43) Pub. Date: Jul. 31, 2008

(54) Automatic Transfer Switch With Monitor Mode and Method Employing the Same

(75) Inventors: Todd Matthew Lathrop, Oakdale, PA (US); Bert Popovich, Carnegie, PA (US)

Correspondence Address: Martin J. Moran;Eaton Electrical, Inc., Technology & Quality Center, 170 Industry Drive, RIDC Park West, Pittsburgh, PA, 15275-1032, US

(73) Assignee: Eaton Corporation

(21) Appl. No.: 11/627,581

(22) Filed: Jan. 26, 2007

(51) Int. Cl. H02J 1/16

(52) U.S. Cl. 307/68

(57) ABSTRACT

An automatic transfer switch having an automatic transfer control provides electric power to a load. The automatic transfer switch includes a power switching device provided with electric power from a first power source having a first status and a second power source having a second status. The automatic transfer control is able to be operated by a mode control to set the automatic transfer control to a monitor mode in which the automatic transfer switch refrains from operating the power switching device, monitors and provides an indication of the first status and of the second status, and provides an indication of how the automatic transfer control would operate the power switching device were the automatic transfer control not set to the monitor mode.

### BACKGROUND OF THE INVENTION

1. Field of the Invention

This invention pertains generally to transfer switches and, more particularly, to automatic transfer switches having a monitor mode in which automatic switching between alternate power sources is disabled. This invention also relates to methods for disabling the automatic transfer function of an automatic transfer switch.

2. Background Information

Transfer switches are employed in a wide variety of residential and commercial structures to allow an electrical load therein to be supplied with power from an alternate power source in the event of instability and/or loss of power from a main power source. A typical transfer switch installation allows an onsite backup electrical generator, serving as a generator power source, to supply electrical power in place of a utility power source on an occasion where the electrical power supplied by the utility power source has become unstable (e.g., as in the case of a brownout) or has failed, entirely.

In the interests of safety, it has become common practice to provide various service disconnects and other mechanisms by which one or more sources of power for a load may be disconnected from the power inputs of an automatic transfer switch and/or at the transfer switch, itself. This is meant to allow maintenance to be performed without maintenance personnel being placed at risk of electrocution as a result of power still being provided from one or more alternate sources, through the transfer switch, and to a load.

Unfortunately, currently available automatic transfer switches often respond to the removal of one or more sources of power for a load by continuing to perform their intended function and switch to another source of power for the load. A possible result of this is that maintenance personnel may be lulled into believing that they have addressed the safety concerns of possible electrocution by disconnecting one or more power sources, and then later discover that a conductor or other component of a transfer switch installation is still electrified as a result of the automatic transfer switch having switched to another source of power that was somehow not disconnected.

This situation of an automatic transfer switch creating a hazardous situation by continuing to perform its function in such a manner has frequently been addressed by maintenance personnel by deactivating the automatic transfer control circuitry of the automatic transfer switch, itself. Unfortunately, although this may prevent the automatic transfer switch from defeating the efforts of maintenance personnel to create an appropriately safe set of conditions under which to do their work, this also removes the benefit of various monitoring functions of the automatic transfer switch that may be of help to such personnel in diagnosing electrical problems.

### SUMMARY OF THE INVENTION

These needs and others are met by embodiments of the invention providing an automatic transfer switch having a monitor mode into which maintenance personnel may place the automatic transfer switch. In the monitor mode, the automatic transfer switch continues to monitor and indicate the status of its power source inputs, as well as to indicate how it would respond to the current status of those power source inputs if it were not in monitor mode.

In accordance with one aspect of the invention, an automatic transfer switch is for a first power source having a first status, a second power source having a second status, and a load. The automatic transfer switch comprises a power switching device structured to select between the first power source and the second power source and to supply power to the load, an automatic transfer control structured to monitor the first status and the second status and further structured to operate the power switching device in response to the first status and the second status, and a mode control structured to be operated to set the automatic transfer control to a first mode wherein the automatic transfer control refrains from operating the power switching device, provides an indication of the first status and of the second status, and provides an indication of how the automatic transfer control would operate the power switching device were the automatic transfer control not set to the first mode.

In accordance with another aspect of the invention, a method is for controlling power provided to a load through a power switching device operated by an automatic transfer control of an automatic transfer switch, the power switching device being structured to receive power from a first power source and a second power source, the first power source having a first status, the second power source having a second status. The method comprises receiving a mode input including one of a first mode and a different second mode, preventing the automatic transfer control from operating the power switching device in response to receipt of the first mode, providing an indication of the first status and the second status, and providing an indication of how the automatic transfer control would operate the power switching device if the mode input was the different second mode.

### BRIEF DESCRIPTION OF THE DRAWINGS

A full understanding of the invention can be gained from the following description of the preferred embodiments when read in conjunction with the accompanying drawings in which:

FIG. 1 is a block diagram of a transfer switch installation in accordance with embodiments of the invention; and

FIG. 2 is a flowchart of an automatic transfer control entering and exiting a monitor mode in accordance with embodiments of the invention.

### DESCRIPTION OF THE PREFERRED EMBODIMENTS

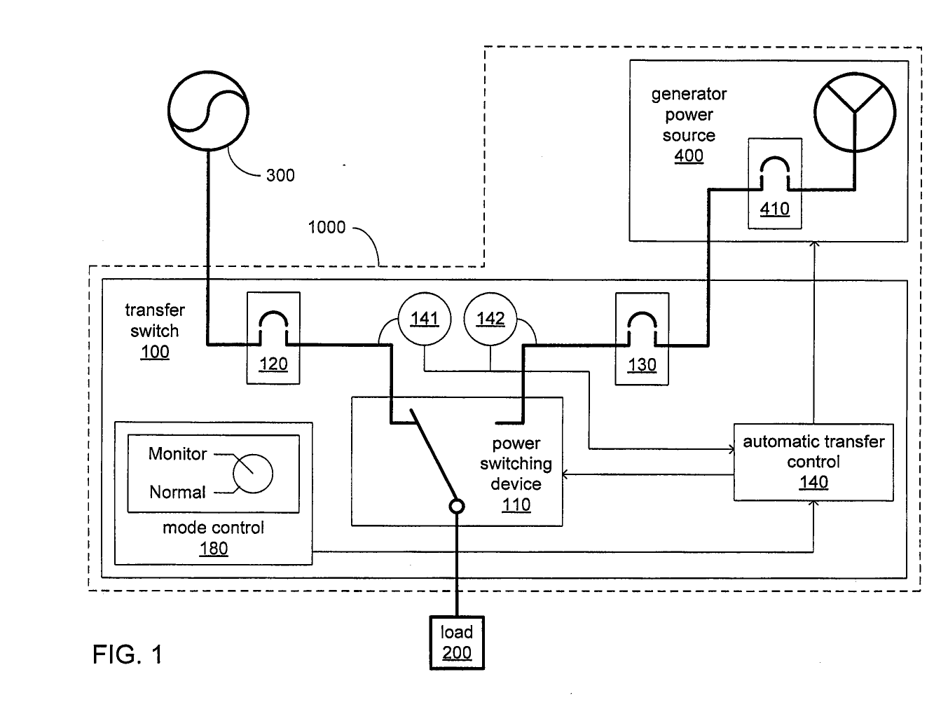

Referring to FIG. 1, a transfer switch installation 1000 to selectively provide electrical power to a load 200 from multiple alternate sources incorporates a generator power source 400 and a transfer switch 100 receiving electric power, at various times, from one or both of a utility power source 300 and the generator power source 400. The transfer switch 100 allows the source of electric power supplied to the load 200 to be switched between the utility power source 300 and the generator power source 400. The load 200 represents one or more electrical devices within, for example, a commercial or residential structure (not shown) that requires electric power, such as for example and without limitation, lighting, plug-ins, appliances, commercial machinery and climate control systems. The utility power source 300 is a source of electric power from a commercial vendor (e.g., without limitation, a connection to an electrical grid maintained by a utility power company).

The generator power source 400 is, for example, an electric generator of a type commonly found near the exterior of a commercial or residential structure to provide a backup source of electric power to that structure in the event that the electric power supplied by the utility power source 300 becomes unstable (as in the case of a brownout) or fails, entirely. The generator power source 400 may incorporate a service disconnect 410 to disconnect power during maintenance and/or in the event of an overload of current being drawn from the generator power source 400. The generator power source 400 may be any of a wide variety of electric generators based on any of a variety of technologies, including but not limited to, solar energy, wind energy, geothermal energy, or fossil fuel energy through either a fuel cell or an internal combustion engine.

The automatic transfer switch 100 incorporates a power switching device 110, an automatic transfer control 140, and a mode control 180. The automatic transfer switch 100 may also incorporate one or both of service disconnects 120 and 130. As will be explained, the mode control 180 provides the ability to manually direct the automatic transfer control 140 to enter into a monitor mode. Electric power from the utility power source 300 is routed via one or more conductors to the power switching device 110, and is routed through the service disconnect 120 if the service disconnect 120 is present. Electric power from the generator power source 400 is routed via one or more conductors from the generator power source 400 to the power switching device 110, and is routed through the service disconnect 130 if the service disconnect 130 is present. The power switching device 110 is caused to select either the utility power source 300 or the generator power source 400 to supply electric power that is routed via one or more conductors from the power switching device 110 to the load 200.

As those skilled in the art will readily recognize, the power switching device 110 may be any of a wide variety of devices or combinations of devices that provide the function of both making and breaking electrical connections for the routing of electric power from one of multiple electrical sources. For example, it is widely known to use one or more sets of relays and/or contactors as a power switching device.

As those skilled in the art will also readily recognize, the service disconnects 120, 130 and 410 may be any of a wide variety of devices or combinations of devices providing both protection against too great a flow of current and manual disconnection capability. A widely known and very common form of device employed as a service disconnect is a circuit breaker. Circuit breakers commonly provide a manual operating handle by which disconnection can be effected, and/or a shunt trip (e.g., without limitation, a magnetic coil that when energized by an external power source causes the circuit breaker to enter an open state). Widely known and commonly used combinations of devices serving as a service disconnect are a fuse and either a latching relay or latching contactor where disconnection is caused by breaking the circuit conveying power for latching.

During normal operation of the automatic transfer switch 100, the power switching device 110 is normally caused by the automatic transfer control 140 to select the utility power source 300 as the source of electric power to be supplied to the load 200, but can be caused to select the generator power source 400 when the electric power supplied by the utility power source 300 becomes unstable or fails. The automatic transfer control 140 is an electronic circuit that causes the power switching device 110 to select between the utility power source 300 and the generator power source 400 in response to the receipt of one or more inputs. Such inputs may include, for example and without limitation, an indication of the input voltage level supplied by one or both of the utility power source 300 and the generator power source 400 failing to meet a desired specification (e.g., without limitation, failing to stay within 5% of a standard 115V level), an indication of the amount of current being drawn from either of these power sources failing to stay within a desired limit (e.g., without limitation, failing to stay within the maximum current capacity of a conductor or power source), or a timer input.

More particularly, voltage and/or other sensors may be employed to directly monitor the voltages, current flow and/or other characteristics of the power supplied by the utility power source 300 and the generator power source 400. In embodiments of the automatic transfer switch 100 in which one or both of the service disconnects 120 and 130 are provided, such sensors may be positioned between the power switching device 110 and one or both of the service disconnects 120 and 130, as exemplified by depicted sensors 141 and 142. This may be done to detect a loss of power at one or both of the power inputs to the power switching device 110 as a result of one or both of the service disconnects 120 and 130 being opened, thereby disconnecting the power supplied by one or both of the utility power source 300 and the generator power source 400. Alternatively, the service disconnects 120, 130 and/or 410 may be structured to allow the automatic transfer control 140 to directly monitor their status. During normal operation, the automatic transfer control 140 may respond to the opening of one or more of the service disconnects 120, 130 and 140 by causing the power switching device 110 to switch between the utility power source 300 and the generator power source 400 in an effort to maintain a supply of power to the load 200.

The automatic transfer control 140 may also be provided with the ability to turn the generator power source 400 on or off. During normal operation, the automatic transfer control 140 may respond to instability or complete loss of power from the utility power source 300 by signaling the generator power source 400 to turn on to provide power. The automatic transfer control 140 may further signal the generator power source 400 to turn off when stable power is once again being supplied by the utility power source 300. The automatic transfer control 140 may further be provided with the ability to monitor one or more aspects of the status of the generator power source 400, such as without limitation, the amount of available fuel remaining for the generator power source 400 (e.g., without limitation, depletion of the fuel to an extent that a fuel tank is only 10% full). During normal operation, a shortage of available fuel for the generator power source 400 may cause the automatic transfer control 140 to limit the amount of time during which the automatic transfer control 140 signals the generator power source 400 to be turned on.

Normal operation, as just described, is enabled by the mode control 180 being moved to a “Normal” position in which the automatic transfer control 140 of the automatic transfer switch 100 is placed in a “normal mode” and is allowed to respond to changes in the status of the power supplied by the utility power source 300 and the generator power source 400 by switching between them. However, when the mode control 180 is moved to a “Monitor” position, the automatic transfer control 140 enters a “monitor mode” in which the automatic transfer control 140 continues to monitor the status of the power supplied by the utility power source 300 and the generator power source 400, as well as other possible inputs, but takes no action to change the state of the power switching device 110 (i.e., in this example, change which one of the utility power source 300 or the generator power source 400 is selected by the power switching device 110) in response to any change in status of any supplied power.

In embodiments in which the automatic transfer control 140 is able to control the generator power source 400, it may be desirable for the automatic transfer control 140 to be prevented from sending signals to the generator power source 400 to cause the generator power source 400 to turn on or to turn off while in the monitor mode. In essence, while the automatic transfer control 140 is in the monitor mode, maintenance personnel are free to manually operate the power switching device 110 and/or one or more of the service disconnects 120, 130 and 410 as needed without the automatic transfer control 140 responding in a manner contrary to their intentions. Instead, in the monitor mode, the automatic transfer control 140 is limited to indicating the status of the utility power source 300 and/or the generator power source 400, indicating other status information that the automatic transfer control 140 may receive from various sensors, and indicating what action the automatic transfer control 140 would take if not in monitor mode. To enable such manual operation, the power switching device 110 and/or one or more of the service disconnects 120, 130 and 140 may provide operating handles or other suitable manual operators.

Furthermore, although the mode control 180 is discussed and depicted as being incorporated into the automatic transfer switch 100, itself, it should be noted that the mode control 180 may be implemented as a remote device providing input to the automatic transfer control 140 through a wired, wireless, optical or other suitable linkage. Alternatively, the equivalent of an input from a mode control 180 may be provided to the automatic transfer control 140 from a electronic controller device (not shown), such as without limitation, a central control system structured to control the automatic transfer switch 100 in addition to other devices and/or systems.

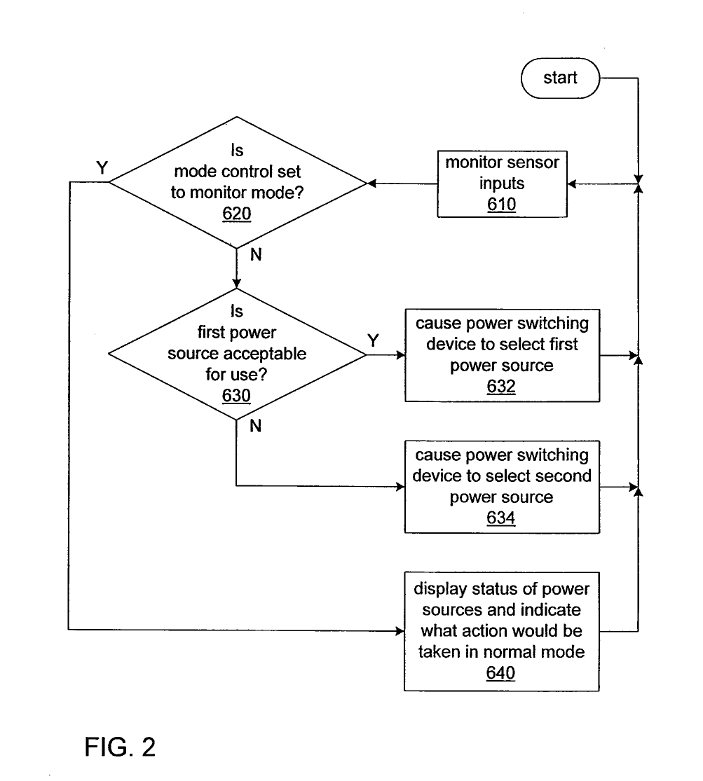

FIG. 2 shows a procedure for an automatic transfer control circuit of an automatic transfer switch entering and exiting a monitor mode. At 610, inputs to the automatic transfer control circuit are monitored for the status of both a first and a second power source, and for whether or not a mode control input to the automatic transfer control circuit has been manually set to a monitor mode, perhaps by maintenance personnel. Additionally, at 610, other inputs to the automatic transfer control circuit may be monitored for other status information, including and not limited to, a fuel level for a generator serving as one of the first or second power sources, time and/or date information that may be determinative of what action is taken depending on the time of day or the day of a week, or outdoor conditions.

At 620, if the mode control has not been operated to be set to a monitor mode, then at 630 a determination is made as to whether the first power source is acceptable for use, or not. As those skilled in the art will readily recognize, the criterion for determining the acceptability of the first power source may greatly vary, and may include, without limitation, such considerations as the voltage level of the first power source, or how much time has passed since some form of instability was recently detected in the electric power provided by the first power source. If the first power source is determined to be acceptable, then at 632, a power switching device is caused to select the first power source, if the power switching device has not already been caused to select the first power source. If the first power source is determined to not be acceptable, then at 634, the power switching device is caused to select the second power source, if the power switching device has not already been caused to select the second power source. Regardless of which power source the power switching device has been caused to select, at 610, inputs to the automatic transfer control circuit are again monitored.

If at 620, the mode control has been operated to be set to a monitor mode, then the automatic transfer control circuit refrains from operating the power switching device and/or controlling a generator. Instead, at 640, the automatic transfer control circuit simply provides an indication of the current status of the first and second power sources, and provides an indication of what action the automatic transfer control circuit would cause the automatic transfer switch to take if the automatic transfer control circuit were not in monitor mode.

It should be noted that although the mode control 180 has been described as being movable between a “Normal” position and a “Monitor” position, other equivalent nomenclature may be used to describe these two settings. More particularly, other terminology may be substituted for denoting a “monitor mode” in which an automated function of a transfer switch is to switch between sources of electric power and/or to cause a generator power source to be turned on or off. Correspondingly, other terminology may be substituted for denoting a “normal mode” in which an automated function of a transfer switch is to switch between a source of electric power and/or to cause a generator power source to be turned on or off is not disabled.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An automatic transfer switch for a first power source having a first status, a second power source having a second status, and a load, said automatic transfer switch comprising:
a power switching device structured to select between the first power source and the second power source and to supply power to the load;
an automatic transfer control structured to monitor the first status and the second status, and further structured to operate the power switching device in response to the first status and the second status; and
a mode control structured to be operated to set the automatic transfer control to a first mode wherein the automatic transfer control refrains from operating the power switching device, provides an indication of the first status and of the second status, and provides an indication of how the automatic transfer control would operate the power switching device were the automatic transfer control not set to the first mode.

2. The automatic transfer switch of claim 1, wherein the power switching device comprises a contactor.

3. The automatic transfer switch of claim 1, wherein the power switching device comprises a first service disconnect structured to receive and disconnect power from the first power source, and a second service disconnect structured to receive and disconnect power from the second power source.

4. The automatic transfer switch of claim 3, wherein the first service disconnect is a first circuit breaker and the second service disconnect is a second circuit breaker.

5. The automatic transfer switch of claim 1, wherein the mode control is further structured to allow the automatic transfer control to operate the power switching device in response to the mode control being operated to cause the automatic transfer control to enter a second mode, which is different from the first mode.

6. The automatic transfer switch of claim 5, wherein the mode control comprises a manually operable switch to select between the first mode and the second mode.

7. The automatic transfer switch of claim 1, wherein the second power source comprises a generator, and wherein the automatic transfer control is further structured to signal the second power source to turn on or to turn off.

8. The automatic transfer switch of claim 7, wherein the automatic transfer control is further structured to refrain from signaling the second power source in response to being set to the first mode.

9. The automatic transfer switch of claim 7, wherein the automatic transfer control is further structured to monitor a characteristic of the generator and to indicate the characteristic of the generator in response to being set to the first mode.

10. A method of controlling power provided to a load through a power switching device operated by an automatic transfer control of an automatic transfer switch, said power switching device being structured to receive power from a first power source and a second power source, said first power source having a first status, said second power source having a second status, said method comprising:
receiving a mode input including one of a first mode and a different second mode;
preventing the automatic transfer control from operating the power switching device in response to receipt of the first mode;
providing an indication of the first status and the second status; and
providing an indication of how the automatic transfer control would operate the power switching device if the mode input was the different second mode.

11. The method of claim 10, said method further comprising preventing the automatic transfer control from signaling the second power source to switch between an on state and an off state.

12. The method of claim 10, wherein said second status comprises a generator status, said method further comprising monitoring the generator status and providing an indication of the generator status.

13. The method of claim 10, said method further comprising employing a manually operable switch to select between the first mode and the different second mode.

14. The method of claim 13, said method further comprising allowing the automatic transfer control to operate the power switching device in response to the different second mode.

15. The method of claim 10, wherein the first mode is a monitor mode.

16. The method of claim 10, wherein the different second mode is a normal mode.
